(19) United States
(12) Patent Application Publication
(10) Pub. No.: US 2015/0153039 A1
(43) Pub. Date: Jun. 4, 2015

(54) WICK HOLDER AND METHOD FOR THE PRODUCTION THEREOF

(71) Applicant: STC GMBH, Bergheim (DE)

(72) Inventors: Joe Cremer, Bedburg (DE); Marcel Cremer, Bedburg (DE)

(21) Appl. No.: 14/406,025

(22) PCT Filed: Jun. 6, 2013
(86) PCT No.: PCT/EP2013/061747

§ 371 Date: Dec. 5, 2014

(30) Foreign Application Priority Data
Jun. 6, 2012 (DE) 10 2012 011 211.4

(51) Int. Cl. F23D 3/24; F21V 35/00; C11C 5/02; F23D 3/16

(52) U.S. Cl. CPC F23D 3/24; F23D 3/16; F21V 35/003; C11C 5/02

(57) ABSTRACT

A wick holder comprising a base plate having a central passage in the form of a hollow cylindrical projection. The cylindrical axis thereof projects perpendicularly from the base plate. A hollow cylindrical extension is attached to the hollow cylindrical projection such that the cylinder axes of the hollow cylindrical projection and the hollow cylindrical extension coincide.

The invention relates to a wick holder which comprises a base plate having a hollow neck portion as a passage for a wick for candles, and a method for the production thereof.

Wick holders are used mainly in tea lights. In order to produce tea lights, preferably paraffin, or a mixture of natural wax with stearin or another suitable combustible material is used, which for example is cold pressed as granulate into an appropriate shape or poured as a liquid into the tea light case. Simpler tea lights are pressed without a wick. A hole is subsequently pierced through the candle body and the wick is fed through said hole into the wick holder. The purpose of the wick holder is substantially to hold the wick straight in the wax.

Typically known wick holders are stamped items, which are produced in various sizes, preferably using so-called progressive combination dies, and preferably from cold-rolled steel or aluminium sheets. The sheet is deformed in the stamping dies, preferably in several stages, until the final geometry of the product is achieved.

A wick holder of the type referred to above, which is suitable particularly for tea lights, which have a cup-shaped container, a wax block inserted into the container and a wick passed through a hole in the wax block, is known from European Published Patent Application EP 2 361 962 A1. The wick is arranged in the wick holder resting on the base of the container, which wick holder has a base plate with a central passage in the form of a hollow cylindrical projection in which the bottom part of the wick is mounted and fixed. The base plate is in the shape of a congruent regular n-square where n=3, 4 or 6 (equilateral triangle, square or regular hexagon), more particularly in the shape of a regular rectangle.

German Published Patent Application DE 33 35 146 A1 describes a method and a device for producing candles arranged in cup-shaped containers, the wick of which candles is attached to a wick holder made of a magnetically attractable material. Said wick holder is set inside the container and centred and temporarily held firmly in position with the help of magnets arranged centrally beneath the container.

German Published Patent Application DE 39 18 324 A1 describes a wick holder, more particularly for tea lights and devotional candles, in which at least one suction opening is provided in the casing of a cylinder portion receiving and retaining the wick, whereby good wax suction takes place. The wick can also be fixed inside the wick holder in the process by the suction openings or the compressed material next to the openings. A method is also described, in which a wick is inserted into the wick holder after the stamping and drawing process, for example, and the cylinder portion is then perforated at at least one point, such that the edges of the perforation engage with the material of the wick in a clamping manner.

Wick holders of different heights are required for candles of different thicknesses. Consequently, in the wake of a European consumer protection regulation, so-called pillar candles (these are often used on Advent crowns) must be configured such that contact between the flame and the base (for example, with the fir branches) is reliably prevented, for example by said candles extinguishing automatically as soon as the flame falls below a specific distance from the base. The ‘neck’ of the wick holder according to the invention extended according to the invention causes candles with a wick holder according to the invention to extinguish automatically as soon as the flame falls below a specific distance from the base. However, since many candle manufacturers have different requirements in terms of the shape of wick holders, said new types of wick holder are only required in relatively small quantities. Acquiring a stamping tool for each individual type is therefore often not cost-effective.

Wicks of different thicknesses are also used and consequently the neck receiving the wick must be adjusted to the thickness of the wick. Candles are also increasingly composed of different burning masses, which require different wicks for optimum burning, which also differ inter alia in terms of diameter.

Different wick holders are therefore required for different candles. This results in the disadvantage that other tools are required for the production of different wick holders and these are expensive. This means that the production of small batches of wick holders in particular is expensive.

One object of the present invention consists in making a cost-effective option available for the provision of wick holders with different dimensions. This object is achieved by a product and a method respectively according to any one of the independent claims.

A wick holder according to the invention of the type referred to above is characterised by a sleeve-type extension piece attached to the neck portion, the axis of which extension piece aligns with the neck portion.

In the context of the description of the present invention, a wick holder should be interpreted as any object into which the bottom end of the wick of a candle can be fixed.

Wick holders according to the invention can be used in memorial candles, glass candles, votive candles or other candles and also in tea lights.

A hollow neck portion as passage for a wick is interpreted here as an opening, more particularly a hollow cylindrical opening, preferably created by deep drawing in the base plate, the cross-section of which opening is dimensioned such that the wick, which the wick holder is intended to hold, can be pushed through or into said opening. If said passage is produced by deep drawing, a so-called ‘neck’ is formed on the base plate in the event of suitable feed-through, i.e. a hollow cylindrical projection, the cylindrical axis of which typically projects perpendicularly from the base plate.

The simplest hollow shape, which can have a neck portion, is a hollow cylinder. Hence reference is also often made to a hollow cylindrical projection in the description below. However, the term ‘neck portion’ also includes other shapes. The neck portion can also be configured with an n-square, more particularly, with a triangular or square cross-section, for example. The neck portion can also be conical or pyramid-shaped, more particularly in the vicinity of the base plate, and, with increasing distance from the base plate, roughly cylindrical, preferably also such that its cross-section or the size of the opening thereof becomes smaller with increasing distance from the base plate.

Typically, the axis of the neck portion runs substantially perpendicular to the plane defined by the base plate, but this does not have to be the case. As a general rule, it should be ensured that the wick is held by the wick holder such that it is guided in a substantially vertical direction. The base plate does not have to be flat either. It can also have a three dimensional shape, for example the shape of a shell of a truncated cone.

The extension piece can be inserted into the neck portion or can surround the neck portion, wherein the extension piece is held in position on the neck portion by a clamping effect. A firm, immoveable connection between neck portion and extension piece is important insofar as the wick holder undergoes various moulding processes during the subsequent process for producing a candle, in which the connection between neck portion and extension piece must not loosen. Example given, vibrating channels are used to transport wick holders into a tapering or threading machine, in which a wick is inserted into the wick holder, in which vibrating channel the position of neck portion and extension piece relative to each other must not vary. The connection is therefore created preferably with a press fit or by means of a wedge-like change of the abutting inner and outer surfaces of neck portion and extension piece. Alternatively, but less preferably, neck portion and extension piece can be connected in another manner, for example by gluing them together.

The connection of extension piece and neck portion should preferably also be liquid-tight, since the wick holder as a whole should have the same features as a single-piece wick holder with a long neck portion.

In order to adjust the internal diameter of the wick holder for use with different wick diameters, the extension piece preferably has, at least in part, a different, more particularly narrower, internal diameter from the neck portion. Conversely, the extension piece can have a larger internal diameter than the neck portion and be placed onto the neck portion.

According to a preferred embodiment of the invention, the wick holder is configured such that the external diameter of the neck portion gets smaller, at least in sections, with increasing distance from the base plate. This facilitates attachment of the extension piece to the neck portion.

These and other embodiments of the present invention have various advantages compared with known wick holders:

As a result of this extension according to the invention, the wick is supported in addition to the supporting effect of the neck. Moreover, the wick cannot burn down any further, at least if the wick is not able to draw in any new burning mass from below, if it has burnt down to the upper edge of the extension. The extension therefore acts as a neck extended in the first place, with the difference that by attaching different extensions onto the neck of a commercially available wick holder, short runs of wick holders according to the invention can also be produced cost-effectively. Cost-effective production of such short runs would be virtually impossible without the invention. The invention thus enables the production of wick holders with extended necks of different lengths based on wick holders with necks of standard length. More cost-effective production of a larger number of different types of wick holders with different length necks extended according to the invention is possible by limiting the stamping dies to a fewer number of different types of wick holders. An extension of the wick holder for using extremely thin wicks is also advantageous. Extremely thin wicks require a better purchase to prevent them from tipping over into the liquid burning mass. This can be achieved by means of the ‘neck’ on the wick holder extended according to the invention.

In a method according to the invention for producing a wick holder according to the invention, a hollow cylindrical extension piece is placed onto or into the hollow neck portion of the wick holder. The extension piece is preferably placed onto the neck portion before the wick holder is inserted into a candle. In this manner, the invention enables the production of a wick holder according to the invention from a conventional wick holder. The purchase of a stamping die for each individual type of wick holder is therefore not necessary.

Preferably, wire ferrules known from the electrical industry are fitted onto known, preferably commercially available wick holders. Preferably, wire ferrules are placed onto said known wick holders as extensions with lengths preferably between 6 mm and 20 mm. Wire ferrules are commercially available products known to a person skilled in the art. See also ‘Wire ferrules’ on Wikipedia, the free encyclopaedia. Status: 12 May 2012, 07:30 UTC. URL: http://de.wikipedia.org/w/index.php?title.Aderendh%/C3%BClse&oldid=103127170 (Viewed on 15 May 2012, 15:53 UTC). Here, wire ferrules are used, the internal diameter of which is measured such that a clamping effect is created automatically when said ferrules are fitted onto the neck portion and that the external diameter of the neck portion and the internal diameter of the wire ferrules produce a press-fit or have a clamping effect at least in one region in which the wire ferrules surround the neck portion. In this way, additional jointing technology for connecting neck portion and extension piece can be dispensed with.

There are various options for fitting extensions onto the necks of known wick holders:

For example, extensions can be fitted with the help of automatic assembly machines developed especially for this purpose. Said automatic assembly machines position the extension piece such that the axes of the extension piece and the neck portion coincide exactly as required in order to attach the extension to the neck portion. The automatic assembly machine then guides the extension piece along the common axis and places it onto the neck portion. An appropriate matching of the external diameter of neck portions and the internal diameter of extension pieces preferably produces a clamping effect when extensions are placed onto necks, which causes extensions to attach to necks.

Such an automatic assembly machine can be provided by converting a so-called ‘threader’ such that said threader can execute the fitting of an extension onto the neck. So-called threaders are typically used in candle factories to join wicks and wick holders together. The advantage of this solution is that said devices require relatively little space, are able to process a large number of units and solve the problem of feeding the wick holder.

In any case, the extension piece is fitted or pushed onto the neck portion before the composite wick holder is equipped with a wick. Multi-piece wick holders can be supplied to candle production as finished parts in exactly the same way as one-piece wick holders. The wick together with the wick holder is then either placed into solid candle wax and then with the solid wax into a candle holder, or the wick is attached to a candle holder into which liquid candle wax is poured, which then cools and solidifies in the candle holder.

The invention is described in more detail below by way of preferred embodiments and using figures.

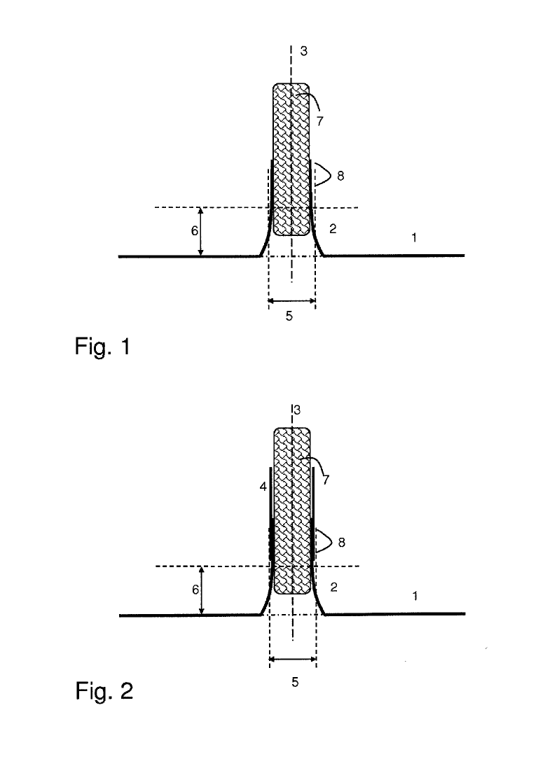

FIG. 1 shows a schematic view of a first example of a known wick holder;

FIG. 2 shows a schematic view of a first embodiment of a wick holder according to the invention;

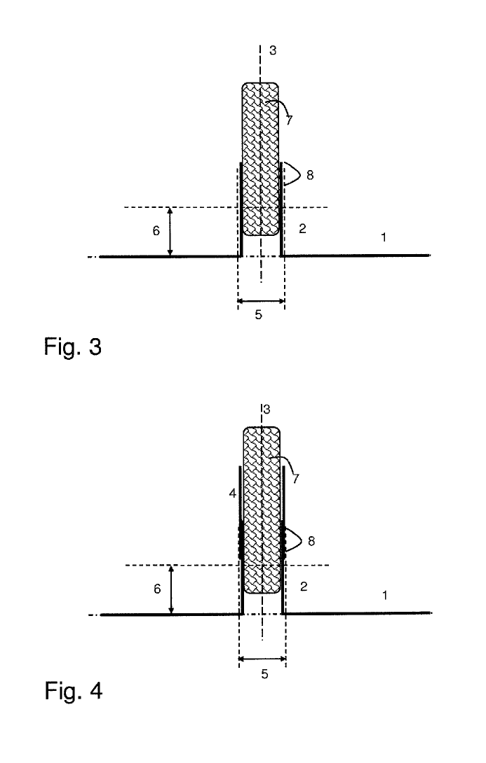

FIG. 3 shows a schematic view of a second example of a known wick holder;

FIG. 4 shows a schematic view of a second embodiment of a wick holder according to the invention;

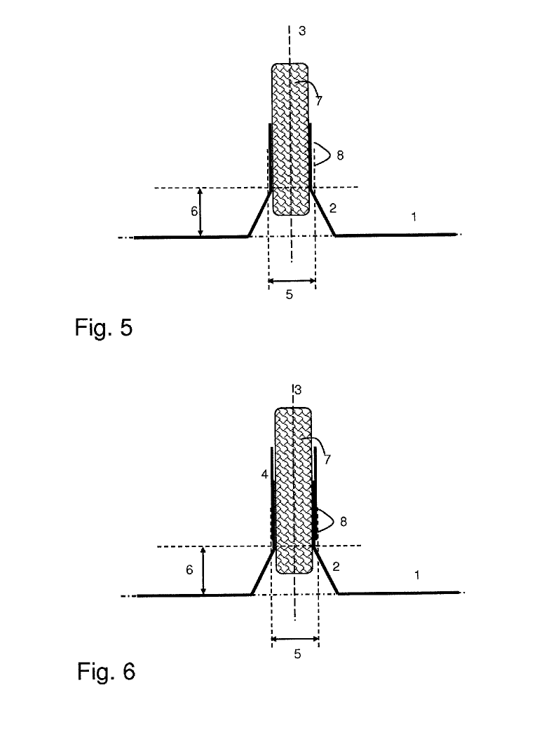

FIG. 5 shows a schematic view of a third example of a known wick holder;

FIG. 6 shows a schematic view of a third embodiment of a wick holder according to the invention.

The following reference numerals are used in these figures:
1 Base plate
2 Hollow cylindrical projection, neck portion
3 Cylindrical axis, symmetrical axis, axis of the projection (neck portion) and extension piece
4 Hollow cylindrical extension piece
5 External diameter of hollow cylindrical projection (neck portion)
6 Distance from the base plate
7 Wick
8 Upper region of the hollow cylindrical projection (neck portion)

A wick holder is provided according to the invention, which comprises a base plate 1 having a central passage in the form of a hollow cylindrical projection 2 (neck portion). The cylindrical axis 3 of said hollow cylindrical projection projects perpendicularly from the base plate 1. Known wick holders also have said features of the wick holder according to the invention, which are suitable as a starting point for the production of a wick holder according to the invention. Unlike the known wick holders (FIGS. 1, 3 and 5), a hollow cylindrical extension 4 (extension piece) is arranged on the hollow cylindrical projection 2 in a wick holder according to the invention, such that the cylindrical axis 3 of the hollow cylindrical projection and the hollow cylindrical extension coincide.

The wick 7 is supported by said extension 4 in addition to the supporting effect of the neck portion 2. Moreover, the wick 7 cannot burn down any further if it has burnt down to the upper edge of the extension 4. The extension therefore acts as a neck extended in the first place with the difference that by attaching different extensions onto the neck of a commercially available wick holder, short runs of wick holders according to the invention can also be produced cost-effectively. Cost-effective production of such short runs would be virtually impossible without the invention.

A wick holder according to the invention can be produced from a known wick holder particularly easily if the external radius 5 of the hollow cylindrical projection (neck portion) gets smaller with increasing distance 6 from the base plate. This is provided in a particularly advantageous manner in the upper region 8 of the hollow cylindrical projection (neck). Since the decrease in the external radius, i.e. the slightly conical course of the neck portion, is preferably so slight in the upper region 8 that a cylindrical tube, preferably a wire ferrule, can be easily attached as an extension piece to the preferably also cylindrical neck portion in the upper region thereof, the slightly conical course of the neck in said region is not shown in the figures.

In the examples shown in FIGS. 1 and 2, the projection (neck portion) initially runs conically in the lower region in the vicinity of the base plate and in the upper region 8 increasingly cylindrically or virtually cylindrically in relation to the base plate. A cylindrical or, more particularly in the upper region 8, a virtually cylindrical projection is shown in FIGS. 3 and 4. The projection of the wick holder shown in FIGS. 5 and 6 is conical or pyramidal in the lower region and cylindrical or virtually cylindrical in the upper region 8.

A wick holder according to the invention can be produced particularly easily using a wick holder produced in a conventional manner from a stamped, more particularly round, metal disc, by deep drawing, and a metal ferrule of an appropriate length. The crossover of the disc of the conventional wick holder to the neck portion (viewed in longitudinal section through the wick holder) is not square, but curved due to the production process. The conical insertion collar of the metal ferrule used as an extension piece is pushed forward and pressed onto the neck portion until the insertion cone of the ferrule is clamped in place on the outer surface of the wick holder, wherein the radius develops a wedge effect in the region of the crossover of base plate and neck portion.

1-11. (canceled)

12. A wick holder, comprising:
a base plate having a hollow neck portion as a passage for a wick, and
a sleeve-type extension piece attached to the neck portion, an axis of which is aligned with an axis of the neck portion,
wherein the extension piece is inserted into the neck portion or surrounds the neck portion, and wherein the extension piece is held firmly in position on the neck portion by a clamping effect.

13. The wick holder according to claim 12, wherein the extension piece is at least in part a hollow cylinder.

14. The wick holder according to claim 12, wherein the extension piece has a different internal diameter from the neck portion, at least in part.

15. The wick holder according to claim 12, wherein an external diameter of the neck portion decreases, at least in sections, with increasing distance from the base plate.

16. A method of producing a wick holder according to claim 12, the method comprising:
placing the extension piece of Claim onto the neck portion of the wick holder of claim 12 or inserting the extension piece into the neck portion of the wick holder of claim 12 before the wick holder is equipped with a wick for the production of a candle.

17. The method according to claim 16, wherein the extension piece is placed onto the neck portion or inserted into the neck portion before the wick holder is introduced into a candle.

18. The method according to claim 16, wherein the extension piece is a wire ferrule with at least one conical insertion collar.

19. The method according to claim 16, further comprising deep-drawing the base plate and the neck portion from a stamped-out metal disc.

20. A method of producing a wick holder according to claim 12, the method including:
using a wire ferrule as the extension piece for the wick holder according to claim 12.

21. The method according to claim 20, further including:
deep-drawing the base plate and the neck portion from a stamped-out metal disc.

22. A candle including the wick holder according to claim 12.
